(19) United States
(12) Patent Application Publication
(10) Pub. No.: US 2024/0042751 A1
(43) Pub. Date: Feb. 8, 2024

(54) HEATING DEVICE

(71) Applicant: Procolored Technology Inc, Pico Rivera (CA)

(72) Inventor: Jiangyu WU, Shenzhen (CN)

(21) Appl. No.: 18/491,359

(22) Filed: Oct. 20, 2023

(30) Foreign Application Priority Data
Dec. 9, 2022 (CN) 202223325797.1

(51) Int. Cl. B41F 23/06; B01D 46/00

(52) U.S. Cl. CPC B41F 23/065; B01D 46/0049; B01D 46/0005; B01D 2273/30

(57) ABSTRACT

A heating device for heating a powder attached to a substrate, including a housing, a heating member, a cover, a fan, and a filter. The housing is provided with a heating cavity. The heating member is accommodated in the heating member, and is configured to heat the powder attached to the substrate after conveyed to the heating cavity. The cover is mounted on the housing, and covers the heating cavity. The fan is mounted on the housing, and an air extraction pipe is arranged between the fan and the heating cavity to enable the fan to extract air from the heating cavity. The filter is provided in the air extraction pipe.

### CROSS-REFERENCE TO RELATED APPLICATIONS

This application claims the benefit of priority from Chinese Patent Application No. 202223325797.1, filed on Dec. 9, 2022. The content of the aforementioned application, including any intervening amendments thereto, is incorporated herein by reference in its entirety.

### TECHNICAL FIELD

The present disclosure relates to digital printing, and more particularly to a heating device.

### BACKGROUND

Currently, it is often required to print some personalized characters and patterns on carriers such as clothes, promotional advertisements, and cups. These characters and patterns can be printed by thermal transfer. For example, the required characters and patterns are printed on a substrate by a printer, and then hot melt powders are evenly dispersed on the area where the characters or patterns are printed; after that, the substrate is heated to convert the hot melt powder into the solid hot melt adhesive; finally, the substrate with the printed characters and patterns is attached to the carrier and heated to enable the printing of the desired characters and patterns on the carrier. However, a small amount of smoke and an unpleasant odor will be generated when heating the hot melt powder on the substrate, which will affect the indoor environment and even threaten the operator's health.

### SUMMARY

In order to solve the technical problems existing in the prior art, the present disclosure provides a heating device, which can reduce the smoke and unpleasant odor produced by heating.

In a first aspect, the present disclosure provides a heating device for heating a powder attached to a substrate, comprising:
a housing;
a heating member;
a cover;
a fan; and
a filter;
wherein the housing is provided with a heating cavity;
the heating member is accommodated in the heating cavity, and is configured to heat the powder attached to the substrate after the substrate is conveyed to the heating cavity;
the cover is mounted on the housing, and is configured to cover the heating cavity;
the fan is mounted on the housing; a pipe is arranged between the fan and the heating cavity; and an interior of the pipe is configured as an air extraction channel to enable the fan to extract air from the heating cavity; and
the filter is provided in the air extraction channel.

The heating device according to the first aspect of the present disclosure has the following beneficial effect: it can reduce the smoke and the unpleasant odor generated by heating.

In some embodiments, a first end of the pipe is connected to the cover, and is communicated with the heating cavity; and a second end of the pipe is connected to the housing, and is opposite to the fan.

In some embodiments, the cover is rotatably arranged on the housing to open or close the heating cavity;
the pipe is a flexible pipe; the first end of the pipe is removably mounted to a first flange from an outside of the housing; the second end of the pipe is removably mounted to a second flange; the first flange is provided on the cover; and the second flange is provided on the housing.

In some embodiments, the fan and the filter are provided in the housing; and the filter is arranged between the second flange and the fan.

In some embodiments, the filter is removably mounted between the second flange and the fan.

In some embodiments, the fan is arranged in the housing through a mounting support, and the mounting support is configured to press the filter to fit the housing.

In some embodiments, the number of the heating member is two or more; each of two or more heating members is a heating pipe; and the two or more heating members are mounted on the cover.

In some embodiments, the heating device further comprises a powder-spreading member; the powder-spreading member is provided behind the heating cavity, and is configured to spread the powder to an upper surface of the substrate.

In a second aspect, the present disclosure provides a heating device for heating a powder attached to a substrate, comprising:
a housing;
a heating member;
a cover;
a fan; and
a filter;
wherein the housing is provided with a heating cavity and an air extraction channel; and a first end of the air extraction channel is connected to the heating cavity;
the heating member is accommodated in the heating cavity, and is configured to heat the powder attached to the substrate after the substrate is conveyed to the heating cavity;
the cover is mounted on the housing, and is configured to cover the heating cavity;
the fan is mounted on the housing, and is opposite to a second end of the air extraction channel; and
the filter is provided in the air extraction channel.

The heating device according to the second aspect of the present disclosure has the following beneficial effect: it can reduce the smoke and the unpleasant odor generated by heating.

In some embodiments, the air extraction channel is filled with the filter.

### DESCRIPTION OF THE DRAWINGS

FIG. 1 is a perspective view of a heating device in accordance with an embodiment of the present disclosure;

FIG. 2 is a schematic diagram of the heating device of FIG. 1 with the cover opened;

FIG. 3 is a sectional view of the heating device along line A-A in FIG. 1;

FIG. 4 is a sectional view of the heating device along line B-B in FIG. 1;

FIG. 5 is a perspective view of the heating device in accordance with an embodiment of the present disclosure viewed from the front; and

FIG. 6 is a perspective view of the heating device of FIG. 5 viewed from the rear.

### DETAILED DESCRIPTION OF EMBODIMENTS

The conception and technical effects of the present disclosure will be clearly and completely described below with reference to the embodiments to fully understand the objects, features and effects of the present disclosure. Obviously, described below are merely some embodiments of the present disclosure, which are not intended to limit the disclosure. All other embodiments obtained by those skilled in the art according to the embodiments disclosed herein without making creative effort should be included within the scope of the present disclosure.

In the description of the embodiments of the present disclosure, orientation or position relationships indicated by terms such as “up”, “down”, “forward”, “rearward”, “left”, and “right”, are based on the orientations or position relationships shown in the drawings, and are used only for ease of describing the disclosure and simplifying the description, rather than indicating or implying that the apparatus or elements should have a particular orientation or be constructed and operated in a particular orientation, and therefore, should not be construed as a limitation on the present disclosure.

In the description of the embodiments of the present disclosure, if a feature is referred to as “set”, “fixed”, “connected”, “mounted” on another feature, it may be directly/indirectly set, fixed, connected, or mounted on another feature. In the description of the present disclosure, “several” means one or more than one, while “multiple” means more than two; “larger than”, “smaller than” and “over” exclude the mentioned number, while “above”, “below” and “within” include the mentioned number. The “first” and “second” in the description are merely intended to distinguish technical features, rather than to indicate or imply relative importance or implicitly indicate a number of the indicated technical features or implicitly indicate a sequence relationship of the indicated technical features.

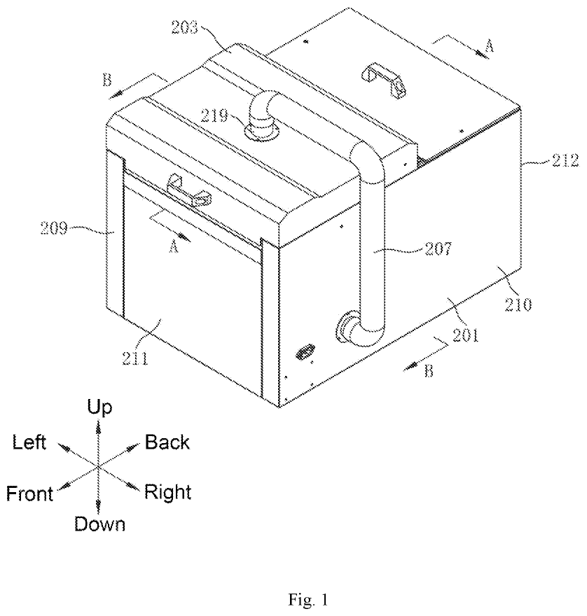

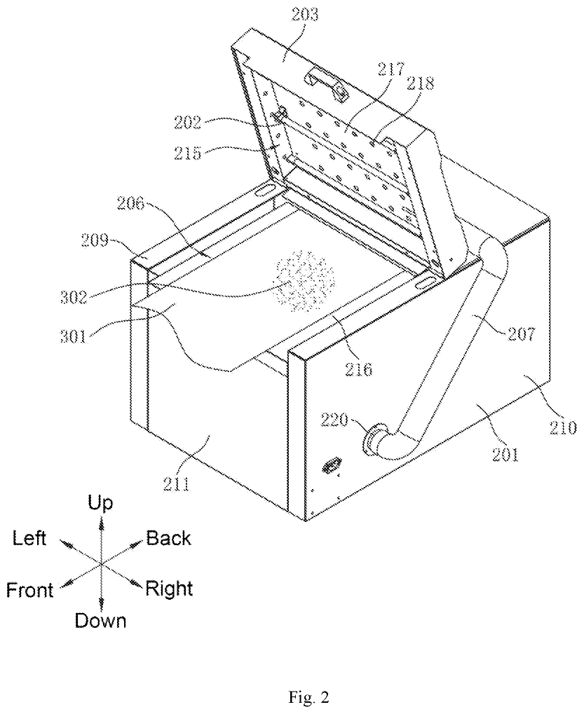

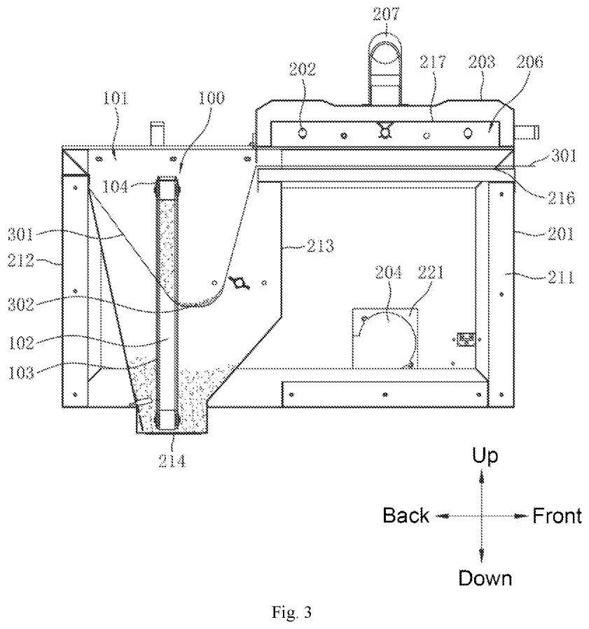

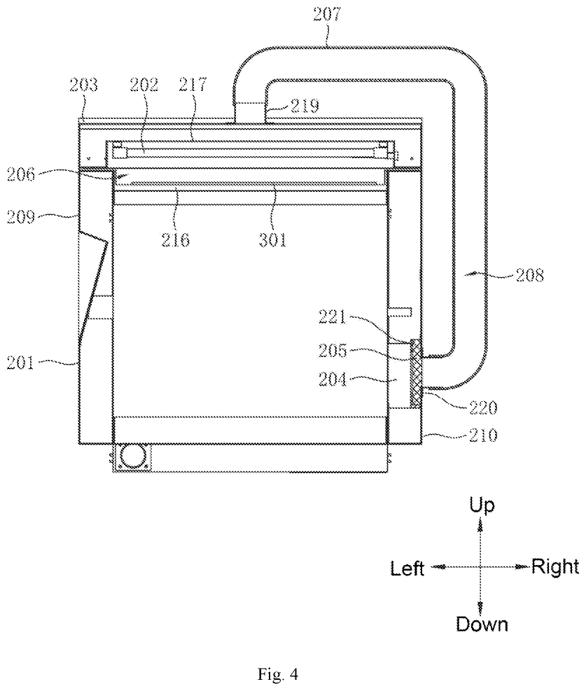

FIG. 1 is a perspective view of a heating device in accordance with an embodiment of the present disclosure. FIG. 2 is a schematic diagram of the heating device of FIG. 1 with the cover opened. FIG. 3 is a sectional view of the heating device along line A-A in FIG. 1. FIG. 4 is a sectional view of the heating device along line B-B in FIG. 1. In addition, in FIGS. 3 and 4, sectional lines are attached only where necessary.

Referring to FIGS. 1 to 4 (mainly to FIGS. 2 and 4), a first embodiment of the disclosure provides a heating device for heating a powder 302 attached to a substrate 301. The heating device includes a housing 201, a heating member 202, a cover 203, a fan 204 and a filter 205. The housing 201 is provided with a heating cavity 206. The heating member 202 is accommodated in the heating cavity 206, and is configured to heat the powder 302 attached to the substrate 301 after conveyed to the heating cavity 206. The cover 203 is mounted on the housing 201, and is configured to cover the heating cavity 206.

The fan 204 is mounted on the housing 201. A pipe 207 is arranged between the fan 204 and the heating cavity 206, and an interior of the pipe 207 is configured as an air extraction channel 208 o enable the fan 204 to extract air from the heating cavity 206. The filter 205 is provided in the air extraction channel 208.

The heating device according to the embodiment can reduce smoke and unpleasant odor generated with heating. Specifically, the fan 204 mounted on the housing 201 is connected the heating cavity 206 through the pipe 207, and the filter 205 is provided in the air extraction channel 208 formed through the pipe 207. Therefore, while the heating member 202 in the heating cavity 206 heats the powder 302 attached to the substrate 301, the hot air in the heating cavity 206 can be continuously discharged through the filter 205. Since the filter 205 can filter the dust generated by the heating of the powder 302, the smoke and unpleasant odor generated by the dust can be reduced.

In addition, the heating device of this embodiment is typically used by individual users in some confined rooms (e.g., print rooms, studios, etc.). Such rooms generally do not have the extraction system, smoke filtration system, dust removal system, etc. for factory environments. By mounting the fan 204 on the housing 201 of the heating device and connecting the fan 204 and the heating cavity 206 through the pipe 207, it is possible to realize a miniature filtration system on the heating device itself, which does not require the user to additionally add other filtration systems in the room, and facilitates the user's use.

With reference to FIG. 3, the housing 201 of the heating device is, for example, a substantially cube-shaped housing welded by means of sheet metal. A power spreading cavity 101 is provided on a rear side of the housing 201, and the heating cavity 206 is provided on a front side of the housing 201. The powder spreading cavity 101 is communicated with the heating cavity 206. A spreading portion 100 is provided in the power spreading cavity 101, and the spreading portion 100 is provided at a rear side of the heating cavity 206 to spread the powder 302 to be heated onto an upper surface of the substrate 301.

The spreading portion 100 is configured to spread powder on the substrate 301. The power spreading portion 100 includes a conveyor synchronous belt 102, a feed channel 103, and a power-spreading member 104 provided in the spreading cavity 101. where at least a bottom 105 of the power spreading cavity may be configured to store the powder 302. The feed channel 103 allows the conveyor synchronous belt 102 to pass through and store the powder 302 being carried by the conveyor synchronous belt 102. The power-spreading member 104 is provided below the upper portion of the conveyor synchronous belt 102. The power-spreading member 104 is communicated with the feed channel 103. The powder 302 is carried by the conveyor synchronous belt 102 through the feed channel 103, and is dispersed toward a storage space 106 via a through hole provided in the power-spreading member 104 as the conveyor synchronous belt 102 is operated.

The substrate 301 may, for example, be a film with text, patterns and the like printed thereon, which are placed both one by one in the power spreading cavity 101, and, in addition, which may also be stored in roll form, while continuously fed and passed through the power spreading cavity 101. The powder 302 may, for example, be a hot melt powder or the like. The substrate 301 is sent to the heating cavity 206 for heating after being powdered in the power spreading cavity 101.

Specifically, the housing 201 is welded together by, for example, a left side plate 209, a right side plate 210, a front side plate 211, a rear side plate 212, a bottom plate 214, and an intermediate spacer 213 provided between the front side plate 211 and the rear side plate 212. The left side plate 209, the right side plate 210, the rear side plate 212, the bottom plate 214, and the intermediate partition 213 collectively form the powder spreading cavity 101. The left side plate 209, the right side plate 210, the front side plate 211, and the intermediate partition 213 collectively form the heating cavity 206. In addition, the front side plate 211, the intermediate partition 213, and the rear side plate 212 are lower than the left side plate 209 and the right side plate 210, respectively, thereby forming a transfer channel capable of transferring the substrate 301.

With reference to FIG. 2 in combination with FIGS. 3 and 4, the cover 203 is rotatably arranged on the housing 201 to open or close the heating cavity 206. Specifically, one end of the cover is mounted to a substantially fore-and-aft oriented intermediate position of an upper portion of the housing 201, thereby being able to be rotatable with respect to the housing 201 so as to open or close the heating cavity 206. On a side of the cover 203 opposite the heating cavity 206, an accommodating cavity 215 is formed, and the heating member 202 is mounted in the accommodating cavity 215 of the cover 203. The heating member 202 may, for example, be a well-known heating tube or the like. The number of heating tubes is not particularly limited, for example, a plurality of heating tubes may be provided in the front-to-back direction. By installing the heating member 202 in the accommodating cavity 215 of the cover 203, it is possible to prevent the user from touching the heating member 202 when operating the substrate 301. For example, since it is necessary to open the cover 203 in order to operate the substrate 301, since the heating member 202 is mounted in the accommodating cavity 215 of the cover 203, after the cover 203 is opened, the heating member 202 is also removed from the heating cavity 206, and thus, it is possible to prevent the user from touching the heating member 202 when operating the substrate 301.

In some embodiments, in order to improve the heating efficiency in the heating cavity 206, the heating cavity 206 may be provided with a first specular member 216, the first specular member 216 being opposite to the heating member 202. The substrate 301 is between the first specular member 216 and the heating member 202. Specifically, as a material for the first specular member 216, for example, mirrored stainless steel may be selected. The first specular reflective member 216 is, for example, directly erected on the front side plate 211 and the intermediate partition 213. In the case where the cover 203 is closed, the first specular member 216 is disposed relative to the heating member 202 disposed in the accommodating cavity 215 of the cover 203. Consequently, the heat from the heating member 202 is reflected by the first specular member 216, which can increase the heating efficiency within the heating cavity 206. The substrate 301 transferred from the power spreading cavity 101 may be directly supported on the first specular member 216, in which case, even if the powder 302 to be heated, for example, hot melt powder, etc., on the substrate 301 is spilled, it will be spilled directly on the first specular member 216, and the spilling of the powder 302 to be heated onto the bottom of the housing 201, etc., can be prevented.

In some embodiments, in order to further improve the heating efficiency within the heating cavity 206, a second specular member 217 is provided on a side of the cover 203 opposite the heating cavity 206, and the heating member 202 is mounted on the side of the second specular member 217 opposite the heating cavity 206. Specifically, the second specular member 217 is provided, for example, within the accommodation cavity 215 of the cover 203, and the second specular member 217, for example, is substantially in the shape of a box and accommodates the heating member 202 within it. Thereby, in the case where the cover 203 is closed, the first specular member 216 and the second specular member 217 are opposite to each other, which can further improve the heating efficiency in the heating cavity 206. In addition, the first specular member 216 and the second specular member 217 are also capable of insulating the heating cavity 206 to a certain extent, inhibiting the heat in the heating cavity 206 from being transferred to the housing 201 and the cover 203, which may result in the surface temperature of the housing 201 and the cover 203 being too high. In addition, in order to facilitate the discharge of smoke and the like within the heating cavity 206, a plurality of air-permeable holes 218 may be provided in the second specular member 217.

The pipe 207 may, for example, be removably mounted to the cover 203 as well as to the housing 201. A first end of the pipe 207 is connected to the cover 203 and is communicated with the heating cavity 206, and a second end is connected to the housing 201 and is opposite to the fan 204. The shape and structure of the pipe 207 is not particularly limited as long as the pipe 207 is capable of connecting the heating cavity 206 and the fan 204 so as to form an air extraction channel 208 to enable the fan 204 to extract air from the heating cavity 206. For example, the pipe 207 may be a hard pipe such as a stainless steel pipe or a flexible pipe such as a bellows. In addition, the pipe 207 may be piped from the interior of the housing 201 or may be piped from the exterior of the housing 201.

In some embodiments, in order to facilitate installation and dismantling of the pipe 207 for users, the pipe 207 is a flexible pipe. The first end of the pipe 207 is removably mounted to a first flange 219 from an outside of the housing 201. The second end of the pipe 207 is removably mounted to a second flange 220. The first flange 219 is provided on the cover 203. And the second flange 220 is provided on the housing 201. The first flange 219 may, for example, be mounted directly to an outer side of the cover 203 by means of screws or the like, and the second flange 220 may also be mounted to an outer side of the housing 201 by means of screws or the like. The shapes of the first flange 219 and the second flange 220 are not particularly limited, and it is sufficient that they have protruding portions so as to facilitate installation of the pipe 207 as a flexible pipe. The pipe 207 can be mounted to the first flange 219 and the second flange 220, for example, by means of a clamp (not shown). By using the flexible pipe as the pipe 207 and configuring the first flange 219 and the second flange 220, it is very easy for the user to install or remove the pipe 207 as needed. In addition, by using the flexible pipe to connect to the cover 203 and the housing 201 from the outside, respectively, it is easy to open or close the cover 203 without interfering with the opening or closing of the cover 203.

With reference to FIG. 4, in some embodiments, the fan 204 and the filter 205 is provided in the housing 201 respectively, the filter 205 is arranged between the second flange and the fan 204. Specifically, the fan 204 is mounted, for example, within the housing 201 and in a space below the heating cavity 206. The fan 204 may be a well-known commercially available fan 204. by mounting the fan 204 within the housing 201, not only can a portion of the hot gases extracted from the heating cavity 206 be shielded by the housing 201 itself, inhibiting these hot gases from emanating outwardly directly toward the outside of the heating device or blowing outwardly directly toward a user, but also, the appearance of the entire heating device can be made more coordinated without creating abruptness in appearance. The filter member 205 may be, for example, a block-shaped foam for filtration, or a block-shaped filter processed from diacetate fiber tow, polypropylene tow, activated carbon, inorganic mineral fibers, or the like. By arranging the filter 205 in the housing 201 and between the second flange 220 and the fan 204, the filter 205 can be reliably fixed, and can be made independent of each other with respect to the pipe 207, so that it is possible to replace the filter 205 or the pipe 207, respectively.

The filter 205 is, for example, removably mounted between the second flange 220 and the fan 204. Specifically, for example, the fan 204 is mounted into the housing 201 via a mounting bracket 221. The mounting bracket 221 presses the filter 205 to fit the filter 205 against the housing 201. For example, the mounting bracket 221 may also be substantially box shaped. The depth of the mounting bracket 221 is less than the thickness of the filter 205. The mounting bracket 221 is mounted to the inside of the housing 201 spaced apart from the filter 205 and is mounted at the location of mounting the second flange 220 of the housing 201. Thus, the filter 205 can be reliably mounted. In addition, the mounting bracket 221 can be provided with a notch for removal, and when the filter 205 needs to be removed and replaced, the filter 205 can be removed directly along the notch.

While the above illustrates an example of a heating device forming a the air extraction channel 208 through a pipe 207, it is not limited thereto.

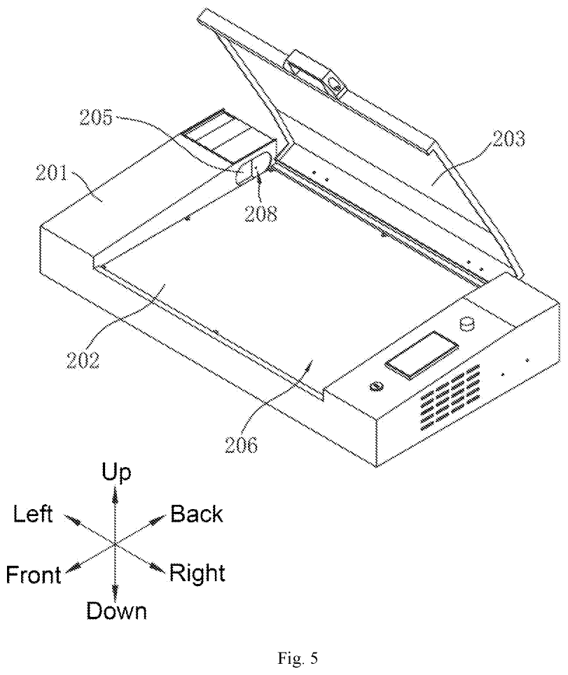

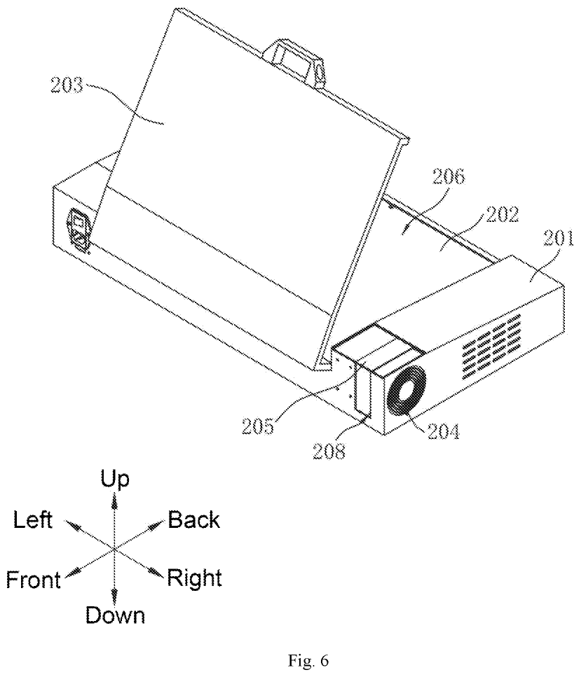

FIG. 5 as well as FIG. 6 are schematic illustrations of an alternative embodiment of the heating device. Furthermore, in FIGS. 5 and 6, the upper portion of the housing 201 at the location where the air extraction channel 208 is provided is partially dissected for ease of illustration. Referring to FIGS. 5 and 6, for example, in the heating device of the second embodiment, it is also possible to form this air extraction channel 208 directly in the housing 201.

Specifically, a second embodiment of the disclosure provides another heating device, which includes a housing 201, a heating member 202, a cover 203, a fan 204, and a filter 205.

The housing 201 is provided with a heating cavity 206 and an air extraction channel 208 formed therein, a first end of the air extraction channel 208 is communicated with the heating cavity 206. The heating member 202 is accommodated in the heating member 202, and is configured to heat the powder 302 (not shown in FIG. and FIG. 6, referring to FIGS. 1 to 4) to be heated attached to the substrate 301 which is delivered to a heating cavity 206 (not shown in FIG. 5 and FIG. 6, refer to FIGS. 1 to 4). The cover 203 is mounted on the housing 201 and covers the heating cavity 206. The fan 204 is mounted on the housing 201, and is opposite to a second end of the air extraction channel 208. The filter 205 is provided in the air extraction channel 208.

The heating device according to the present embodiment can reduce smoke generated with heating as well as an unpleasant odor. Specifically, the fan 204 is mounted on the housing 201, the air extraction channel 208 is provided in the housing 201 connecting the fan and the heating cavity 206, and the filter 205 is provided in the air extraction channel 208. Therefore, while the heating member 202 in the heating cavity 206 heats the powder 302 to be heated attached to the substrate 301, the hot air in the heating cavity 206 can be continuously discharged through the filter 205. Since the filter 205 can filter the dust generated by the heating of the powder 302 to be heated, the smoke and unpleasant odor generated by the dust can be reduced.

In addition, the heating device of this embodiment is typically used by individual users in some confined rooms (e.g., print rooms, studios, etc.). Such rooms generally do not have the extraction system, smoke filtration system, dust removal system, etc. for factory environments. By mounting the fan 204 on the housing 201 of the heating device and connecting the fan 204 and the heating cavity 206 through the air extraction channel 208 in the housing 201, it is possible to realize a miniature filtration system on the heating device itself, which does not require the user to additionally add other filtration systems in the room, and facilitates the user's use.

In this embodiment, the filter 205 may fill the entire air extraction channel 208 to improve the filtration efficiency. Specifically, since the air extraction channel 208 is directly opened in the housing 201, it can be set into various shapes according to practical needs. For example, the air extraction channel 208 may be provided at a corner location of the housing 201. Moreover, the path of the extension of the exaction channel 208 is not required to be long, as long as there is sufficient space to fill the filter 205. Thus, it is possible to easily fill the entire air extraction channel 208 with the filter 205. The filter 205 can be selected with reference to the filter 205 in the first embodiment.

In an embodiment, the heating member 202 may also be plate shaped and laid directly in the heating cavity 206.

The specific technical features described in the above embodiments can be combined in any way as long as no contradiction, and for the sake of unnecessary repetition, various possible combinations are not separately described herein.

Described above are only illustrative of the technical solutions of the present disclosure, and should not be construed as a limitation on the scope of the disclosure. Any modifications or equivalent replacements made by those skilled in the art without departing from the scope of the present disclosure shall fall within the scope of the present disclosure.

What is claimed is:

1. A heating device for heating a powder attached to a substrate, comprising:
a housing;
a heating member;
a cover;
a fan; and
a filter;
wherein the housing is provided with a heating cavity;
the heating member is accommodated in the heating cavity, and is configured to heat the powder attached to the substrate after the substrate is conveyed to the heating cavity;
the cover is mounted on the housing, and is configured to cover the heating cavity;
the fan is mounted on the housing; a pipe is arranged between the fan and the heating cavity; and an interior of the pipe is configured as an air extraction channel to enable the fan to extract air from the heating cavity; and
the filter is provided in the air extraction channel.

2. The heating device of claim 1, wherein a first end of the pipe is connected to the cover, and is communicated with the heating cavity; and a second end of the pipe is connected to the housing, and is opposite to the fan.

3. The heating device of claim 2, wherein the cover is rotatably arranged on the housing to open or close the heating cavity;
the pipe is a flexible pipe; the first end of the pipe is removably mounted to a first flange from an outside of the housing; the second end of the pipe is removably mounted to a second flange; the first flange is provided on the cover; and the second flange is provided on the housing.

4. The heating device of claim 3, wherein the fan and the filter are provided in the housing; and the filter is arranged between the second flange and the fan.

5. The heating device of claim 4, wherein the filter is removably mounted between the second flange and the fan.

6. The heating device of claim 5, wherein the fan is arranged in the housing through a mounting support, and the mounting support is configured to press the filter to fit the housing.

7. The heating device of claim 1, wherein the number of the heating member is two or more; each of two or more heating members is a heating pipe; and the two or more heating members are mounted on the cover.

8. The heating device of claim 1, further comprising:
a powder-spreading member;
wherein the powder-spreading member is provided behind the heating cavity, and is configured to spread the powder to an upper surface of the substrate.

9. A heating device for heating a powder attached to a substrate, comprising:
a housing;
a heating member;
a cover;
a fan; and
a filter;
wherein the housing is provided with a heating cavity and an air extraction channel; and a first end of the air extraction channel is connected to the heating cavity;
the heating member is accommodated in the heating cavity, and is configured to heat the powder attached to the substrate after the substrate is conveyed to the heating cavity;
the cover is mounted on the housing, and is configured to cover the heating cavity;
the fan is mounted on the housing, and is opposite to a second end of the air extraction channel; and
the filter is provided in the air extraction channel.

10. The heating device of claim 9, wherein the air extraction channel is filled with the filter.
